(19) United States
(12) Patent Application Publication
(10) Pub. No.: US 2008/0125128 A1
(43) Pub. Date: May 29, 2008

(54) APPARATUS AND METHOD FOR AVOIDING INTERFERENCE DURING A CALL IN A PORTABLE TERMINAL

(75) Inventors: Taig-Jong Yoo, Yongin-si (KR); Jae-Woong Jeon, Suwon-si (KR); Sang-Eun Han, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/778,950

(22) Filed: Jul. 17, 2007

(30) Foreign Application Priority Data
Nov. 28, 2006 (KR) 2006-0118029

(51) Int. Cl. H04Q 7/20

(52) U.S. Cl. 455/437

(57) ABSTRACT

Provided are a method and apparatus for avoiding interference during a call in a portable terminal that supports Unlicensed Mobile Access (UMA). The method includes measuring a Carrier to Interference and Noise Ratio (CINR) of a channel in which a call is established, and comparing the CINR with a predetermined first threshold; if the CINR of the channel is greater than the first threshold, searching for a peripheral channel and measuring a CINR of the peripheral channel; comparing the CINR of the peripheral channel with a predetermined second threshold; and if the CINR of the peripheral channel is less than the second threshold, determining that is a handover to be performed to the peripheral channel.

### PRIORITY

This application claims priority under 35 U.S.C. §119 to an application filed in the Korean Intellectual Property Office on Nov. 28, 2006 and assigned Serial No. 2006-118029, the contents of which are incorporated herein by reference.

### BACKGROUND OF THE INVENTION

1. Field of the Invention

The present invention relates generally to a method and apparatus for avoiding interference during a call in a portable terminal, and, in particular, to a handover method and apparatus for avoiding interference from an external signal during a call in a portable terminal that supports an Unlicensed Mobile Access (UMA) protocol.

2. Description of the Related Art

An Unlicensed Mobile Access (UMA) protocol is a technique that supports a handover between a wireless mobile communication network and a fixed Internet Protocol (IP) network in both voice and data sessions, thereby allowing users to establish a communication link while moving between the wireless mobile communication network and the fixed IP network.

In general, portable terminals supporting UMA transmits and receives signals by using a frequency band of 2.4 GHz in order to use the fixed IP network. The frequency band of 2.4 GHz refers to an Industrial, Scientific and Medical (ISM) band, i.e., a common frequency band available for a wireless Local Area Network (LAN), which has been used for household electronic appliances, such as microwave ovens, wireless telephones, and Bluetooth® devices. Thus, if the portable terminal establishes a communication link using the fixed IP network, signal interference may be caused by another electronic appliance that uses the frequency band of 2.4 GHz.

A conventional portable terminal supporting UMA provides a method of canceling interference from a Bluetooth® device that uses the frequency band of 2.4 GHz. However, in this case, interference is canceled by simply changing a Bluetooth® frequency channel used in a portable terminal into another frequency channel. Accordingly, a conventional portable terminal supporting UMA is not capable of removing interference generated by an external signal.

### SUMMARY OF THE INVENTION

An aspect of the present invention is to substantially solve at least the above problems and/or disadvantages and to provide at least the advantages below. Accordingly, an aspect of the present invention is to provide a method and apparatus for avoiding interference during a call in a portable terminal.

Another aspect of the present invention is to provide a method and apparatus for avoiding interference from an external signal by performing a handover from a portable terminal that supports an Unlicensed Mobile Access (UMA) protocol to a peripheral channel.

According to one aspect of the present invention, there is provided a method of avoiding interference during a call in a portable terminal that supports Unlicensed Mobile Access (UMA), the method including measuring a Carrier to Interference and Noise Ratio (CINR) of a channel in which a call is established, and comparing the CINR with a predetermined first threshold; searching for a peripheral channel and measuring a CINR of the peripheral channel if the CINR of the channel is greater than the first threshold; comparing the CINR of the peripheral channel with a predetermined second threshold; and determining that a handover is to be performed to the peripheral channel if the CINR of the peripheral channel is less than the second threshold.

According to another aspect of the present invention, there is provided an apparatus for avoiding interference during a call in a portable terminal that supports UMA, the apparatus including a CINR measurement unit that measures a CINR of a channel in which a call is established, and searches for a peripheral channel around the channel and measures a CINR of the peripheral channel, depending on whether a handover determination unit determines that a handover needs to be performed; and the handover determination unit that compares the CINR of the channel with a predetermined first threshold in order to determine whether a handover needs to be performed, and determines a peripheral channel to which a handover is to be performed by comparing the CINR of the peripheral channel with a predetermined second threshold.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a portable terminal according to the present invention;

FIG. 2 is a flowchart illustrating a handover process for avoiding interference during a call in a portable terminal according to the present invention; and

FIGS. 3A and 3B are graphs illustrating the strengths of a received signal and an interfering signal during a call in a portable terminal according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail if it is determined that they would obscure the invention in unnecessary detail.

The present invention provides a method and apparatus for avoiding interference from an external signal during a call in a portable terminal that supports Unlicensed Mobile Access (UMA) by performing a handover to a peripheral channel.

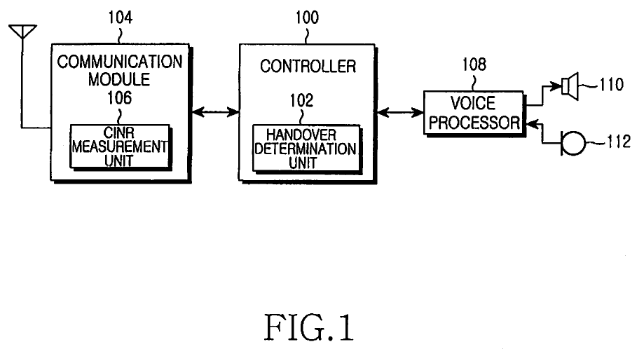

FIG. 1 is a block diagram of a portable terminal according to the present invention. The portable terminal includes a controller 100, a handover determination unit 102, a communication module 104, a Carrier to Interference and Noise Ratio (CINR) measurement unit 106, a voice processor 108, a speaker 110, and a microphone 112. Hereunder, CINR is described as an example of an interference value. SNR(Signal to Noise Ratio) may be used as an example value.

Referring to FIG. 1, the controller 100 performs the overall operation for establishing voice calls and data communications in the portable terminal. In particular, according to an embodiment of the present invention, the controller 100 includes the handover determination unit 102, and thus can control and process functions of comparing a CINR received from the communication module 104 with a predetermined threshold so as to determine whether interference is generated by an external signal, and searching for a peripheral channel not being interfered with by the external signal and performing a handover to the peripheral channel if it is determined that the interference is generated.

The handover determination unit 102 receives from the communication module 104 the CINR of a channel in which a call is established, and compares the CINR with a predetermined first threshold to determine whether the CINR is greater than the first threshold. If the CINR is greater than the first threshold, the handover determination unit 102 determines that interference is generated by the external signal and a handover thus needs to be performed to a peripheral channel, and then transmits a peripheral channel search signal to the communication module 104. Thereafter, the handover determination unit 102 receives the CINR of the peripheral channel from the communication module 104 and compares it with a predetermined second threshold. If the CINR of the peripheral channel is less than the second threshold, the handover determination unit 102 determines that a handover needs to be performed to the peripheral channel and thus controls the communication module 104 to request that a corresponding base station or Access Point (AP) permit a handover to the peripheral channel. If the CINR of the peripheral channel is greater than the second threshold, the handover determination unit 102 transmits the peripheral channel search signal to the communication module 104. Here, the first and second thresholds are preferably experimentally obtained.

The communication module 104 includes a mobile communication network module and a UMA network module, and processes signals exchanged with a mobile communication network and a UMA network. The communication module 104 includes the CINR measurement unit 106 that measures the CINR of a signal received during a call and transmits it to the handover determination unit 102 of the controller 100. Also, if the communication module 104 receives the peripheral channel search signal from the handover determination unit 102, the communication module 104 searches for a peripheral channel near the channel in which the call is established, receives a signal from the searched peripheral channel, measures the CINR of the peripheral channel using the CINR measurement unit 106, and transmits the measured CINR to the handover determination unit 102. In this case, the peripheral channel may be a fifth channel from among channels in a range from ±5 around the channel in which the call is established. Also, the communication module 104 requests that the corresponding base station or AP permit a handover to the peripheral channel, under control of the handover determination unit 102.

The voice processor 108, also referred to as Coder-Decoder (CODEC), inputs or outputs a voice signal via the microphone 112 and the speaker 110 connected to the voice processor 108. For example, the voice processor 108 transforms Pulse Code Modulation (PCM) data provided from the controller 100 into an analog voice signal and outputs the analog voice signal via the speaker 110, and transforms a voice signal received from the microphone 112 into PCM data and transmits the PCM data to the controller 100.

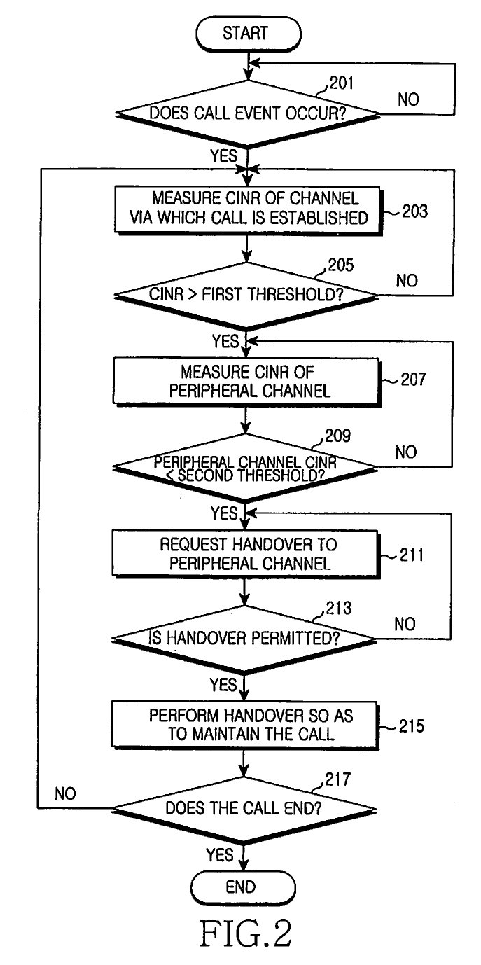

FIG. 2 is a flowchart illustrating a handover process for avoiding interference during a call in a portable terminal, according to the present invention. Referring to FIG. 2, if a call event occurs in step 201, the terminal measures the CINR of a signal received from a channel in which the call is established, that is, the CINR of a signal received during the call in step 203. Next, the terminal compares the measured CINR with a predetermined first threshold in order to determine whether the channel is interfered with by an external signal in step 205. If the measured CINR is less than or equal to the first threshold, the terminal determines that the channel is not interfered with by the external signal, and returns to step 203 and continuously measures the CINR of a signal received during the call.

If the measured CINR is greater than the first threshold, the terminal determines that the channel is interfered with by the external signal and a handover thus needs to be performed, and thus proceeds to step 207. In step 207, the terminal searches for a peripheral channel around the channel and measures the CINR of the searched peripheral channel. Here, the peripheral channel is for example a fifth channel from among channels in a range from ±5 around the channel. Next, the terminal compares the measured CINR of the peripheral channel with a predetermined second threshold to determine whether the peripheral channel is interfered with by an external signal in step 209. If the CINR of the peripheral channel is equal to or greater than the second threshold, the terminal returns to operation 207 and searches for another peripheral channel.

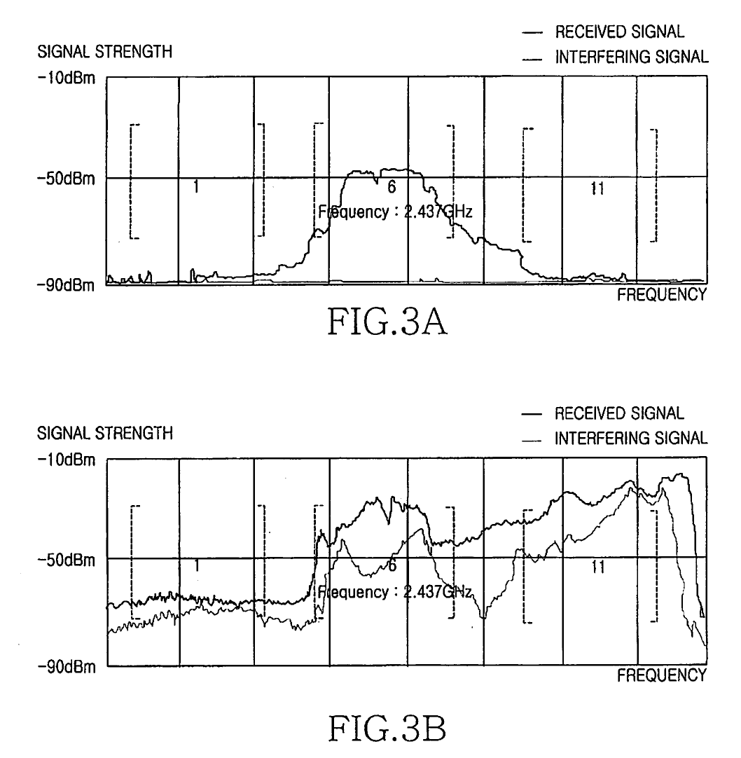

If the CINR of the peripheral channel is less than the second threshold, the terminal determines that a handover needs to be performed to the searched peripheral channel, and requests that a corresponding base station or AP permit a handover in step 211. Thereafter, the terminal determines whether the base station or the AP permits the handover in step 213. If the handover is permitted, the terminal performs the handover to the searched peripheral channel, thereby maintaining the call in step 215. For example, as illustrated in FIG. 3A, if a channel 6 is not interfered with by an external signal, the terminal establishes a call utilizing the channel 6. However, as illustrated in FIG. 3B, if the channel 6 in which a call is established is interfered with by an external signal and the CINR of the channel 6 increases accordingly, then the CINRs of peripheral channels 1 and 11 are measured, and a handover is performed to the peripheral channel 1 that is not interfered with by the external signal, thereby maintaining the call.

Next, the terminal checks if the call ends in step 217. If the call does not end, the terminal returns to step 203 so as to measure the CINR of the peripheral channels to the channel in which the call is being established, and performs the operations following step 203. If the call ends, the terminal ends the algorithm according to the present invention.

As described above, according to the present invention, the CINR of a channel in which a call is established in a portable terminal that supports UMA is measured in order to determine whether the channel is interfered with by an external signal. If interference from the external signal is sensed, a handover is performed to a peripheral channel that the external signal creates less interference with, thereby maintaining the call. Accordingly, it is possible to prevent the call from being discontinued and to prevent lowering or the quality of the call, due to interference from the external signal.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDS), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of avoiding interference during a call in a portable terminal supporting Unlicensed Mobile Access (UMA), the method comprising:
measuring a Carrier to Interference and Noise Ratio (CINR) of a channel in which a call is established and comparing the CINR with a predetermined first threshold;
if the CINR of the channel is greater than the first threshold, searching for a peripheral channel and measuring a CINR of the peripheral channel;
comparing the CINR of the peripheral channel with a predetermined second threshold; and
if the CINR of the peripheral channel is less than the second threshold, determining that a handover is to be performed to the peripheral channel.

2. The method of claim 1, further comprising:
requesting a base station or access point to permit a handover to the peripheral channel; and
if the base station or the access point permits the handover to the peripheral channel, performing the handover to the peripheral channel, thereby maintaining the call.

3. The method of claim 1, further comprising:
if the CINR of the channel is less than or equal to the first threshold, maintaining the channel.

4. The method of claim 1, further comprising:
if the CINR of the peripheral channel is equal to or greater than the second threshold, searching for another peripheral channel and measuring a CINR of the searched peripheral channel.

5. An apparatus for avoiding interference during a call in a portable terminal supporting Unlicensed Mobile Access (UMA), the apparatus comprising:
a Carrier to Interference and Noise Ratio (CINR) measurement unit for measuring a CINR of a channel in which a call is established, searching for a peripheral channel and measuring a CINR of the peripheral channel, depending on whether a handover determination unit determines that a handover needs to be performed; and
the handover determination unit for comparing the CINR of the channel with a predetermined first threshold to determine whether the handover needs to be performed, and determining a peripheral channel to which a handover is to be performed by comparing the CINR of the peripheral channel with a predetermined second threshold.

6. The apparatus of claim 5, further comprising:
a communication module for requesting a base station or access point to permit the handover to the selected peripheral channel, and performing the handover to a selected peripheral channel if the base station or the access point permits the handover.

7. The apparatus of claim 5, wherein the handover determination unit determines that the handover needs to be performed if the CINR of the channel is greater than the first threshold, and selects a peripheral channel as a channel to which a handover is to be performed, where the CINR of the selected peripheral channel is less than the second threshold.

8. A method of avoiding interference during a call in a portable terminal, the method comprising:
measuring an interference of a channel in which a call is established and comparing the interference with a predetermined first threshold;
if the interference of the channel is greater than the first threshold, searching for a peripheral channel and measuring a interference of the peripheral channel;
comparing the interference of the peripheral channel with a predetermined second threshold; and
if the interference of the peripheral channel is less than the second threshold, determining that a handover is to be performed to the peripheral channel.

9. The method of claim 8, further comprising:
requesting a base station to permit a handover to the peripheral channel; and
performing the handover to the peripheral channel, thereby maintaining the call.

10. The method of claim 8, further comprising:
if the interference of the channel is less than or equal to the first threshold, maintaining the channel.

11. The method of claim 8, further comprising:
if the interference of the peripheral channel is equal to or greater than the second threshold, searching for another peripheral channel.

12. An apparatus for avoiding interference during a call in a portable terminal, the apparatus comprising:
means for measuring an interference of a channel in which a call is established and comparing the interference with a predetermined first threshold;
means for searching for a peripheral channel and measuring a interference of the peripheral channel if the interference of the channel is greater than the first threshold;
means for comparing the interference of the peripheral channel with a predetermined second threshold; and
means for determining that a handover is to be performed to the peripheral channel if the interference of the peripheral channel is less than the second threshold.

13. The apparatus of claim 12, further comprising:
means for requesting a base station to permit a handover to the peripheral channel; and
means for performing the handover to the peripheral channel, thereby maintaining the call.

14. The apparatus of claim 12, further comprising:
means for maintaining the channel if the interference of the channel is less than or equal to the first threshold.

15. The apparatus of claim 12, further comprising:
means for searching for another peripheral channel if the interference of the peripheral channel is equal to or greater than the second threshold.

16. A computer-readable recording medium having recorded thereon a program for avoiding interference during a call in a portable terminal, comprising:
a first code segment, for measuring an interference of a channel in which a call is established and comparing the interference with a predetermined first threshold;
a second code segment, for searching for a peripheral channel and measuring a interference of the peripheral channel if the interference of the channel is greater than the first threshold;
a third code segment, for comparing the interference of the peripheral channel with a predetermined second threshold; and
a fourth code segment, for determining that a handover is to be performed to the peripheral channel if the interference of the peripheral channel is less than the second threshold.
